(19) United States
(12) Patent Application Publication
(10) Pub. No.: US 2010/0250537 A1
(43) Pub. Date: Sep. 30, 2010

(54) METHOD AND APPARATUS FOR CLASSIFYING A CONTENT ITEM

(75) Inventor: Steven Leonardus Josephus Dimphina Elisabeth Van De Par, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,154

(22) PCT Filed: Nov. 12, 2007
(86) PCT No.: PCT/IB07/54586

§ 371 Date: May 8, 2009

(30) Foreign Application Priority Data
Nov. 14, 2006 (EP) 06124026.3

(51) Int. Cl. G06F 17/30

(52) U.S. Cl. 707/737; 707/E17.091

(57) ABSTRACT

Newly created personal classes can be incorporated into classification of a content item, step 201. A first set of content item are manually classified, step 203 to define the newly created personal class such that the class can be incorporated for automatically classifying further content items.

### FIELD OF THE INVENTION

The present invention relates to a method and apparatus for classifying a content item.

### BACKGROUND OF THE INVENTION

New techniques for distributing and storing content items such as audio information allow users to gather very large music collections. Using such a large music collection to the full benefit becomes a challenge for the user and techniques need to be developed to assist the user in accessing the music collection. Music classification is a technique that allows the user to organize the music collection according to some predefined categories such as for example the genres of music, or the moods associated with the music. Automatic music classification systems classify music in one or more categories based on classification models. It is a drawback of the known systems that its pre-defined categories often do not match the categories perceived by a user. Although the user can sometimes manually classify his music into personal categories, he needs to do this for his entire music collection, which takes a significant amount of work.

### SUMMARY OF THE INVENTION

The present invention seeks to provide classification of content items to include a new personal class while limiting the amount of effort required from the user to perform such classification.

This is achieved according to an aspect of the present invention by a method of classifying a content item into at least one of a plurality of classes, the plurality of classes comprising at least one pre-defined class and at least one personal class, the method comprising the steps of: manually classifying a first set of content items into the at least one personal class; defining the personal class on the basis of the manual classification of the first set of content items; automatically classifying further content items into at least one of the plurality of classes, the plurality of classes including the defined personal class.

This is also achieved according to another aspect of the present invention by an apparatus for a method of classifying a content item into at least one of a plurality of classes, the plurality of classes comprising at least one pre-defined class and at least one personal class, the method comprising the steps of: manually classifying a first set of content items into the at least one personal class; defining the personal class on the basis of the manual classification of the first set of content items; automatically classifying further content items into at least one of the plurality of classes, the plurality of classes including the defined personal class.

In this way, a user can define personal categories by manually classifying a first set of his content items. His further content items are automatically classified based on the manual classification. A user that wants to create personal categories needs to classify the first set of his content items anyway. The inventors have recognized that this manual classification can additionally be used to train a model for the personal class, thereby enabling automatic classification.

In a preferred embodiment, the step of automatically classifying further content item into at least one of the plurality of classes includes extracting at least one feature of a content item and classifying the content item on the basis of the value of the extracted at least one feature. The personal class may be initially defined on the basis of the at least one predefined class by establishing relationships between at least one extracted feature of the predefined class and at least one extracted feature of the personal class and weighting the relationships to provide a best match between the at least one extracted feature of said pre-defined class and at least one extracted feature of said personal class. Further, the personal class may be redefined on the basis of user feedback.

In essence, the pre-defined classes are linked by the relationships to the new personal classes and classification is initially done through these links as some characteristics of pre-defined classes may, to a certain extent, be similar or correlated to characteristics of the personal class. As a result less training data is required and the personal class can be utilized more quickly. At the same time users can continue training the model with new personal classes while they are using the system by providing feedback which redefines the personal class. Gradually, the newly trained model will become more reliable and will take over the classification according to the predefined classes.

A number of predefined sets of classes may be available in the application, for example according to genre (classical, pop, rock, etc.) or mood (sad, happy, relaxed) or suitable occasion to play the track (coming home, party, attentive listening, resting, reading a book). Each set can have its own classification model. According to the present invention combination of predefined sets of classes links that define the classes can easily be established allowing the new personal classes to be used in the classification more readily.

### BRIEF DESCRIPTION OF DRAWINGS

For a more complete understanding of the present invention, reference is now made to the following description take in conjunction with the accompanying drawings.

FIG. 1 is a simplified schematic diagram of apparatus according to an embodiment of the present invention; and

FIG. 2 is a flowchart of the method steps of defining a newly created personal class or classes according to an embodiment of the present invention.

### DETAILED DESCRIPTION OF EMBODIMENTS OF THE INVENTION

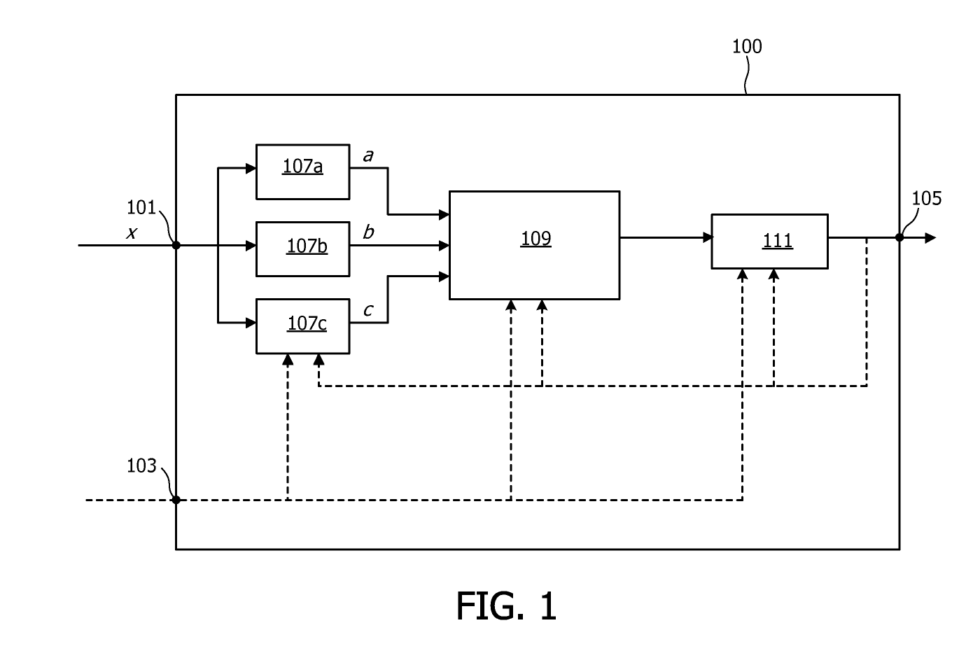

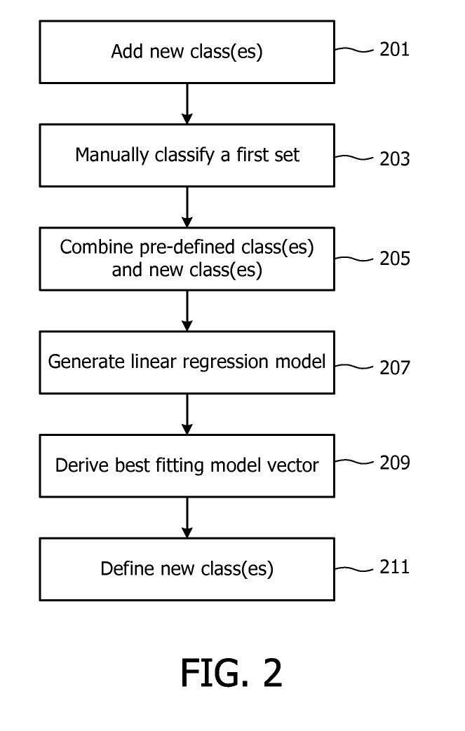

An embodiment of the present invention will now be described with reference to FIGS. 1 and 2.

With reference to FIG. 1, the apparatus 100 comprises first and second input terminals 101, 103 and an output terminal 105. The first input terminal 101 is connected to the inputs of a plurality of classifiers 107a, 107b, 107c. Although 3 classifiers are illustrated here, it can be appreciated that any number of classifiers may be utilized. Each classifier 107a, 107b, 107c comprises a plurality of classes. In the particular example illustrated, it is assumed that the first and second classifiers 107a and 107b are pre-defined classifiers and that the third classifier 107c is a newly created personal classifier. The third classifier 107c is also connected to the second input terminal 103. The output of each classifier 107a, 107b, 107c is connected to a regression modeler 109. The regression modeler 109 is also connected to the second input terminal 103. The output of the regression modeler 109 is connected to a meta classifier 111. The meta classifier 111 is also connected to the second input terminal 103. The output of the meta classifier 111 is connected to the output terminal 105 of the apparatus 100. The output of the meta classifier is also connected via a feedback line to the meta classifier 111, the regression modeler 109 and the third classifier 107c.

The operation of the apparatus 100 will now be described in more detail with reference to FIG. 2.

The apparatus of FIG. 1 may be part of an audio player that is running on a multi media PC that contains a large collection of audio tracks. The apparatus may also be utilized to classify other content items such as video files or multimedia files. The first and second classifiers 107a, 107b of the apparatus 100 classify the audio tracks input on the first input terminal 101 into one of the two sets of classes, set A of the first classifier 107a and set B of the second classifier 107b. As an example the two sets A and B of classes are:

### Set A:

### Classical

Pop music

### Jazz

Rock music

### Other

### Set B:

Happy music
Melancholic music
Relaxed music
Spiritual music

### Other

For both sets a trained model is available which was delivered together with the audio player. The mathematical description of the first and second classifiers 107a, 107b is given by the following pair of equations:

ā=Ā( x̅) and

b̅= B̅( x̅)

Here x is the feature vector that was extracted from one particular audio track, A is the classifier function of the first classifier 107a which results in a classification vector a where each of the components indicates the prevalence of the various classes that are present in the model. For example, if a₂ is greatest then the audio track is classified as “Pop music” by the first classifier 107a, thus the component of a that has the largest value indicates the most likely class of set A.

Similarly and independently of the equation for set A, there is an equation for classification set B of the second pre-defined classifier 107b which results in a classification vector b.

It is now assumed that the user of the audio player wants to create a number of personal classes in classification set C for the new, third classifier 107c, such as, for example:

Listening music
Party music
Book reading music
Other music

Although initially the classification model will not give any valid prediction, it can be described in a similar mathematical way as the other two sets:

c̅= C̅( x̅)

The classification vectors a, b, and c are combined to form a new ‘feature’ vector, step 205, i.e.

d̅=└ā; b̅; c̅┘

The length of vector d is equal to the sum of lengths of vectors a, b, and c and is denoted with M.

A linear regression model is then built on the new feature vector d, step 207, by the regression modeler 109 to classify the underlying feature vector x. Although a linear regression model is implemented here, it can be appreciated that any technique for reusing classification results could be implemented. It is also assumed that N audio tracks of a first set having corresponding feature vectors x are manually classified by the user according to the new class set C, step 203. The vectors are denominated as x̅ⁿ, where n indicates the n-th vector of N vectors that are available in total. By using each of the feature vectors in the respective models A, B, and C, the N vectors are obtained that are denominated as d̅ⁿ, where n indicates that we are dealing with the n-th vector. For each of the N audio tracks, a classification is available which is denominated by k_{m,n}“. When k_{m,n}” is equal to 1 it means that audio track n is classified as class m. When k_{m,n} is equal to zero it means that audio track n is not classified as class m. With these definitions the linear regression model can be applied on the following matrix multiplication:

$$( \begin{matrix}{k}_{m , 1} \\ {k}_{m , 2} \\ ⋮ \\ ⋮ \\ {k}_{m , N}\end{matrix} ) = ( \begin{matrix}{d}_{1}^{1} & {d}_{2}^{1} & … & … & {d}_{M}^{1} \\ {d}_{1}^{2} & {d}_{2}^{2} & & & \\ ⋮ & & & & ⋮ \\ ⋮ & & & & \\ {d}_{1}^{N} & & … & & {d}_{M}^{N}\end{matrix} ) ( \begin{matrix}{T}_{m , 1} \\ {T}_{m , 2} \\ ⋮ \\ ⋮ \\ {T}_{m , M}\end{matrix} )$$

Here the vector T̅ₘ denotes weighting coefficients for each of the elements of the new feature vector d. Thus, T_{m,p} is the weighting coefficient for class m and new feature vector component p. Using a linear regression method the best fitting model vector T̅ₘ can be found assuming that N>M. In other words, the best fitting model vector T̅ₘ is found that after the matrix multiplication results in the closest match to the vector k in a least square sense. For each class m this linear regression method can be applied to derive the best fitting model vector T, step 209.

Once all vectors Tₘ are derived the classes of the third classifier 107c can be defined, step 211, and the third classifier 107c is then included in the classification of further feature vectors x. This will result in a new feature vector d̅^{x}. By applying the following vector multiplication the classification variable k is obtained and output by the regression modeler 109.

$$( {k}_{m} ) = ( \begin{matrix}{d}_{1}^{x} & {d}_{2}^{x} & … & … & {d}_{M}^{x}\end{matrix} ) ( \begin{matrix}{T}_{m , 1} \\ {T}_{m , 2} \\ ⋮ \\ ⋮ \\ {T}_{m , M}\end{matrix} )$$

When kₘ is close to zero this is an indication that the feature vector x (and the corresponding audio track) does not belong to class m, when kₘ is close to one this is an indication that the feature vector x belongs to class m. Similarly classification variables k can be derived for all other classes and this information is used in a meta classifier 111 to determine the most likely class (e.g. by using quadratic discriminant analysis).

As indicated, since the new personal class set C is not been well trained, the classification vector c will not contain consistent data in the initial phase when the new personal class is used. The regression modeler 109 will notice this and the weighting factors corresponding to the classification vector c will be low in value. Instead of using the new personal class set, the best match to the predefined classes will be made. Maybe for this user the new class label ‘Party music’ will correspond almost one to one to the label ‘Happy music’ of class set B and the corresponding weighting value in the vector T will be high.

It is assumed that during further use of the audio player, the user will give feedback about the classification and the new personal class set C will become better trained. It is expected that after some time the new personal class set C and the corresponding model will provide better information than the predefined class sets A and B. In this case the linear regression model will adapt its weighting such that only the classification vector c will be used and the predefined classifiers for sets A and B will contribute only little or nothing to the determination of the new personal classes.

The dotted lines of FIG. 1 indicate information that is used for training and improving the training of the third classifier 107c. The user can give feedback about which class the audio track is supposed to belong to via the second input terminal 103. Two feedback scenarios are envisaged:

The first is that the user only gives feedback when the classification result was incorrect. In this case, by implication, when there is no feedback it will be assumed that the classification of the meta classifier 111 was correct. The third classifier 107c is informed about this and updates its internal classification model accordingly. Updated classification vectors c based on past feature vectors and the present vector will be transmitted to the linear regression model 109, which will update its internal model. In turn the various classification variables k resulting from the input classification vectors c will be used by the meta classifier 111 to update its internal model. Furthermore when there is feedback, i.e. the classification was incorrect, a similar update is carried out.

The second scenario is that the user will always give explicit feedback about correctness or incorrectness of the classification (the non-preferred option). In this case all updates of internal classification models will be based on the user feedback.

The number of predefined classifiers 107a, 107b of FIG. 1 should be at least one and can be any number equal or greater than 1. Secondly, the present invention can be utilized for training the regression modeler 109 and the meta classifier 111 only. In this case user feedback is still utilized for the training of the regression modeler 109 and the meta classifier 111.

This invention can be used in any application that uses audio classification and which may benefit from the presence of personally defined classes such as, software on multi-media PCs, solid state audio players (MP3 players), home network servers, etc.

Although this invention was presented in the context of audio classification it is much more general than that and can be applied to any type of classification where predefined classes are possible but where there is a need for personal categories also; i.e. in video content classification.

Although an embodiment of the present invention has been illustrated in the accompanying drawings and described in the foregoing description, it will be understood that the invention is not limited to the embodiment disclosed but capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of classifying a content item into at least one of a plurality of classes, said plurality of classes comprising at least one pre-defined class and at least one personal class, the method comprising the steps of:
manually classifying a first set of content items into said at least one personal class;
defining said personal class on the basis of the manual classification of the first set of content items; and
automatically classifying further content items into at least one of said plurality of classes, said plurality of classes including said defined personal class.

2. A method according to claim 1, wherein the step of automatically classifying further content items into at least one of said plurality of classes includes the steps of:
extracting at least one feature of a content item;
classifying said content item on the basis of the value of said extracted at least one feature.

3. A method according to claim 2, wherein the step of defining said personal class includes:
defining said personal class initially on the basis of said at least one predefined class.

4. A method according to claim 3, wherein the step of defining said personal class initially further includes:
establishing relationships between at least one extracted feature of said pre-defined class and at least one extracted feature of said personal class;
weighting said relationships to provide a best match between said at least one extracted feature of said pre-defined class and at least one extracted feature of said personal class.

5. A method according to claim 1, wherein the step of defining said personal class comprising the step of:
redefining said personal class on the basis of user's feedback.

6. A computer program product comprising a plurality of program code portions for carrying out the method according to claim 1.

7. Apparatus for classifying a content item into at least one of a plurality of classes, said plurality of classes comprising at least one pre-defined class and at least one personal class, the apparatus comprising the steps of:
means for manually classifying a first set of content items into said at least one personal class;
means for defining said personal class on the basis of the manual classification of the first set of content items; and
means for automatically classifying further content items into at least one of said plurality of classes, said plurality of classes including said defined personal class.
